(19) United States
(12) Patent Application Publication
(10) Pub. No.: US 2023/0310118 A1
(43) Pub. Date: Oct. 5, 2023

(54) Tooth Extraction Device

(71) Applicants: Dominique Aimee Jean, New York, NY (US); Kevin Smith, Oklahoma City, OK (US)

(72) Inventors: Dominique Aimee Jean, New York, NY (US); Kevin Smith, Oklahoma City, OK (US)

(21) Appl. No.: 18/194,784

(22) Filed: Apr. 3, 2023

Related U.S. Application Data
(60) Provisional application No. 63/327,098, filed on Apr. 4, 2022.

(51) Int. Cl. A61C 3/14

(52) U.S. Cl. CPC A61C 3/14

(57) ABSTRACT

The present invention is an extraction device for teeth. The extraction device is designed for grasping, capturing, and fully removing a tooth (or teeth) from inside an individual's mouth. The extraction device has an elongated handle with a plurality of selectively retractable/extendable prongs (i.e., three or four) that can latch onto a loose tooth. The handle can include a chamber or cavity for holding the extracted tooth. The extraction device can be a single person/patient use device or a single tooth device. The handle can include a pair of wings or arms extending from opposing sides of the handle to provide finger rests to enhance the grip of a user's hand and the maneuverability of the extraction device.

### CROSS-REFERENCE TO RELATED APPLICATION

The present application claims priority to, and the benefit of, U.S. Provisional Application No. 63/327,098, which was filed on Apr. 4, 2022 and is incorporated herein by reference in its entirety.

### FIELD OF THE INVENTION

The present invention relates generally to the field of tooth extraction. More specifically, the present invention relates to a novel multipurpose extraction device designed for efficiently and effectively extracting teeth. The device can include an extended handle for easy manipulation and accessibility into a recipient's mouth. A pair of wings or arms extending outward from opposing sides of the handle can be used as finger rests for enhancing the grip on the extraction device. Accordingly, the present disclosure makes specific reference thereto. Nonetheless, it is to be appreciated that aspects of the present invention are also equally applicable to other like applications, devices, and methods of manufacture.

### BACKGROUND

By way of background, a child or individual having a loose primary or secondary tooth can risk losing the loose tooth at an inopportune time. Loss of a tooth, for example, can occur during medical procedures in which the individual is under anesthesia. In the process of administering anesthesia and in the process of advanced airway management (i.e., intubation, LMA insertion, oral airway insertion, etc.) the loose tooth can become dislodged. Laryngeal mask airway (LMA) ventilation is a method for providing rescue ventilation to unconscious patients or patients without a gag reflex that is technically easier than use of most other effective ventilatory methods. It is used by anesthesiologists in many settings that previously required endotracheal intubation.

A dislodged tooth can fall back into the individual's mouth and throat and can obstruct the airway above the vocal cords. Obstructions can cause a physical barrier to adequate ventilation (i.e., moving of air in and out) as well as potentially causing laryngospasm. Laryngospasm can result in the involuntary closing of the vocal cords which can then create further complications potentially causing morbidity and/or mortality. During the course of an anesthetic procedure, loss of a tooth can physically move down the trachea, the bronchus, or into the lung. This can cause an acute obstructive breathing problem, pneumonitis, atelectasis (i.e., collapsing of the alveoli and small air exchanging areas of the lung) and pneumonia. The patient or individual undergoing such procedure would have to undergo a separate additional procedure (i.e., emergent bronchoscopy) in order to remove the tooth.

One of the main problems with tooth extraction is that during extraction, when trying to remove the tooth from an individual's mouth, the tooth can escape and fall back further into the mouth and throat.

Another problem with tooth extraction is lack of ability to grasp, capture, and secure the extracted tooth. The lack of ability to capture and secure the extracted tooth leads to the aforementioned issues.

Another problem is that one's fingers are difficult to maneuver in another person's mouth, especially when trying to remove a wet tooth.

Therefore, there exists a long felt need in the art for a tooth extraction and tooth capture device that effectively grasps, captures, and removes a tooth from an individual's mouth. There is also a long felt need in the art for an improved extraction device that can be used by non-dental medical personnel to facilitate extraction of a tooth or highly mobile teeth prior to an anesthetic procedure. Additionally, there is a long felt need in the art for a tooth extraction device that prevents airway obstruction and aspiration that is often associated with loose teeth that have been dislodged while a patient is under anesthesia. Moreover, there is a long felt need in the art for an extraction device that obviates additional procedures that may be needed in order to retrieve a tooth that was accidentally dislodged and swallowed during a surgical procedure. Further, there is a long felt need in the art for an extraction device that can be used to both secure and retain the removed tooth inside a safe and sanitary chamber within the device.

The subject matter disclosed and claimed herein, in one embodiment thereof, comprises a portable extraction and capturing device for securing a tooth from an individual's mouth. The extraction device is designed for grasping, capturing, and storing a tooth in order to safely remove the tooth. The extraction device features an extended handle, a plurality of prongs, a chamber, and a pair of opposing wings or arms used as finger rests.

In this manner, the multifunctional extraction device of the present invention accomplishes all of the forgoing objectives and provides users with an improved tool for fully removing a tooth from inside an individual's mouth. The tool or device is easily handled by non-dental personnel. The device can be handled easily using one hand and safely removes a tooth from a person's mouth.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an extraction device for teeth. The extraction device is designed for grasping, capturing, and fully removing a tooth (or teeth) from inside an individual's mouth. The extraction device has an elongated handle with a plurality of selectively retractable/extendable prongs (i.e., three or four) that can latch onto a loose tooth. The handle can include a chamber or cavity for holding the extracted tooth. The extraction device can be a single person/patient use device or a single tooth device. The handle can include a pair of wings or arms extending from opposing sides of the handle to provide finger rests to enhance the grip of a user's hand and the maneuverability of the extraction device.

In yet another embodiment, an extraction device for capturing and removing a tooth from an individual's mouth is disclosed. The device can be made of plastic and include a generally rigid handle having a button, slide, or plunger. The slide or plunger can be actuated to push on a rod downward inside the handle in order to extend the plurality of prongs at one end of the extraction device. Once over a loose tooth, the slide or plunger can be actuated again to pull the rod upward and to retract the prongs over the loose tooth and to capture the loose tooth. The slide can be further retracted wherein the tooth is further retracted with the prongs into the handle where the tooth is retained in the chamber or cavity. It is to be appreciated that the tooth can be expelled from the chamber in the handle by once again actuating the slide or plunger to extend the plurality of prongs outward from one end of the extraction device, wherein the tooth can be released.

In yet another embodiment, a first wing or arm is formed by a first elongated extension protruding from one side of the handle, and a second wing or arm is formed by a second elongated extension protruding from another opposing side of the handle.

In yet another embodiment, a method of removing a tooth from an individual's mouth is described. The method comprising the steps of providing an extraction device having a handle, a slide actuator, a rod, and a plurality of prongs; actuating the slide; moving the rod downward in the handle; extending the plurality of prongs outward from one end of the handle; aligning the prongs over a loose tooth; actuating the slide; moving the rod upward in the handle; retracting the plurality of prongs around the tooth; and, continuing retracting the plurality of prongs to move the tooth into a cavity in the handle.

In yet another embodiment, the tooth extraction device of the present invention is easily and efficiently manufactured, marketed, and available to consumers in a cost-effective manner and is easily used by users for grasping and removing a loose tooth from an individual's mouth.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an elevational view of one potential embodiment of an extraction device of the present invention in accordance with the disclosed architecture;

FIG. 2 illustrates an elevational view of one potential embodiment of the extraction device with a tooth captured in a cavity in accordance with the disclosed architecture; and

FIG. 3 illustrates a perspective view of one potential embodiment of the tooth extraction device of the present invention in accordance with the disclosed architecture and wherein the prongs are grasping a tooth.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a tooth extraction and tooth capture device that effectively grasps, captures, and removes a tooth from an individual's mouth. There is also a long felt need in the art for an improved extraction device that can be used by non-dental medical personnel to facilitate extraction of a tooth or highly mobile teeth prior to an anesthetic procedure. Additionally, there is a long felt need in the art for a tooth extraction device that prevents airway obstruction and aspiration that is often associated with loose teeth that have been dislodged while a patient is under anesthesia. Moreover, there is a long felt need in the art for an extraction device that obviates additional procedures that may be needed in order to retrieve a tooth that was accidentally dislodged and swallowed during a surgical procedure. Further, there is a long felt need in the art for an extraction device that can be used to both secure and retain the removed tooth inside a safe and sanitary chamber within the device.

The present invention, in one exemplary embodiment, is a method for removing a loose tooth from an individual's mouth. The method comprising the steps of providing an extraction device having a handle, a slide actuator, a rod, and a plurality of prongs; actuating the slide; moving the rod downward in the handle; extending the plurality of prongs outward from one end of the handle; aligning the prongs over a loose tooth; actuating the slide; moving the rod upward in the handle; retracting the plurality of prongs around the tooth; and, continuing retracting the plurality of prongs to move the tooth into a cavity in the handle.

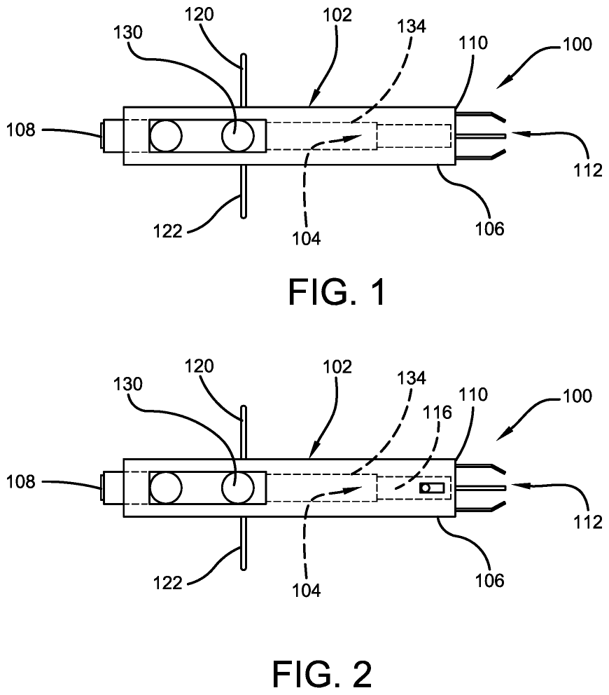

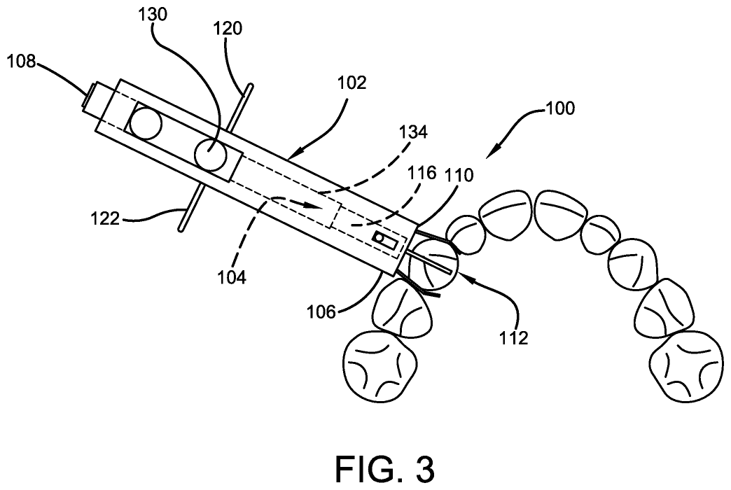

Referring initially to the drawings, FIG. 1 illustrates an elevational view of one potential embodiment of a multipurpose extraction device of the present invention in accordance with the disclosed architecture. The multipurpose extraction device 100 of the present invention is a tooth extraction device for grasping and capturing a loose tooth from an individual's mouth. The extraction device 100 further comprising a handle body 102 having a curvilinear shape, the handle body 102 having an interior 104, an exterior 106, a curved top edge with a top actuator 108, and an open bottom end 110 having a plurality of spring biased prongs 112. The spring biased prongs 112 can be extended and expanded from the bottom end 110 to surround a loose tooth, and then the prongs 112 can be retracted and contracted into the bottom end to grasp the tooth to help a user to hold and capture the tooth easily and effectively as illustrated in FIG. 3. If desired, further retraction of the spring biased prongs 112 can move the tooth inside the handle body 102 for retention in a cavity 116 inside the handle body 102.

The handle body 102 has an elongated configuration to reach inside an individual's mouth. The handle body 102 has a smooth exterior 106 including a first wing or arm 120 and an opposing second wing or arm 122. The arms 120, 122 extend outward from the exterior 106 of the handle body 102 to provide finger rests to improve grip and maneuverability of the extraction device 100.

The spring biased prongs 112 are biased to the extended and retracted positions by actuating a slide actuator 130 which can be moved up and down the handle body 102 to move a rod or plunger 134 up and down within the handle body 102. Movement of the slide actuator 130 translates to movement of the rod or plunger 134, and in turn, movement of the spring biased prongs 112 outward (i.e., extended) and inward (i.e., retracted). The top actuator 108 and the slide actuator 130 can be selectively biased to extend and retract the spring biased prongs 112.

The present extraction device 100 is designed to be extended into an individual's mouth for grasping and removing a tooth. In one exemplary embodiment, a method for removing a loose tooth from an individual's mouth is disclosed. The method comprising the steps of providing an extraction device 100 having a handle 102, a slide actuator 130, a top actuator 108, a rod or plunger 134, and a plurality of spring biased prongs 112; actuating the slide actuator 130 or top actuator 108; moving the rod or plunger 134 downward in the handle 102; extending the plurality of prongs 112 outward from one end 110 of the handle 102; aligning the prongs 112 over a loose tooth; actuating the slide actuator 130; moving the rod or plunger 134 upward in the handle 102; retracting the plurality of prongs 112 around the tooth; and, continuing retracting the plurality of prongs 112 to move the tooth into a cavity 116 in the handle 102. It is to be appreciated that a user can place an index finger on one arm 120 and a middle finger on the opposing arm 122 to assist with gripping the extraction device 100 and maneuvering same in an individual's mouth.

Further, the extraction device 100 comes in different colors, designs, and is preferably made from heavy-duty plastic. The multifunctional extraction device 100 of the present invention is disposable.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “extraction device”, “tooth extraction device”, “multifunctional extraction device”, “device”, and “improved tooth extraction device” are interchangeable and refer to the multifunctional extraction device 100 of the present invention.

Notwithstanding the forgoing, the multifunctional tooth extraction device 100 of the present invention can be of any suitable size and configuration as is known in the art without affecting the overall concept of the invention, provided that it accomplishes the above stated objectives. One of ordinary skill in the art will appreciate that the multifunctional extraction device 100 as shown in the FIGS. are for illustrative purposes only, and that many other sizes and shapes of the multifunctional extraction device 100 are well within the scope of the present disclosure. Although the dimensions of the multifunctional extraction device 100 are important design parameters for user convenience, the multifunctional extraction device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tooth extraction device comprising:
a handle body including a curvilinear shape;
wherein said handle body having an interior, an exterior, a curved top edge with a top actuator, and an open bottom end including a plurality of prongs;
wherein said handle body having a slide actuator;
wherein said slide actuator actuates said prongs through said bottom end from a retracted position to an extended position;
wherein said prongs in said extended position positioned over a tooth; and
further wherein said prongs in said retracted position secured around the tooth.

2. The tooth extraction device of claim 1, wherein said prongs are spring biased prongs.

3. The tooth extraction device of claim 2, wherein said spring biased prongs in said extended position surround a majority of the tooth.

4. The tooth extraction device of claim 2, wherein said spring biased prongs are actuated selectively by said top actuator and said slide actuator.

5. The tooth extraction device of claim 2, wherein said spring biased prongs in said fully retracted position captures the tooth and retains the tooth in a cavity of said handle body.

6. The tooth extraction device of claim 5, wherein said exterior is a smooth exterior.

7. The tooth extraction device of claim 6, wherein said smooth exterior having a pair of opposing arms extending therefrom for providing finger rests to said tooth extraction device.

8. The tooth extraction device of claim 7, further comprising a plunger connecting said slide actuator and said spring biased prongs, and further wherein said plunger actuates said spring biased prongs when said slide actuator is moved downward and upward relative to said handle body.

9. A tooth extraction device comprising:
a handle body including a curvilinear shape;
wherein said handle body having an interior, an exterior, a curved top edge with a top actuator, and an open bottom end including a plurality of prongs;
wherein said handle body having a slide actuator;
wherein said slide actuator actuates said prongs through said bottom end from a retracted position to an extended position;
wherein said prongs in said extended position positioned over a tooth;
wherein said prongs in said retracted position secured around the tooth;
a plunger connecting said slide actuator and said prongs; and
further wherein said plunger actuates said prongs when said slide actuator is moved downward and upward relative to said handle body.

10. The tooth extraction device of claim 9, wherein said prongs are spring biased prongs.

11. The tooth extraction device of claim 10, wherein said spring biased prongs in said extended position surround a majority of the tooth.

12. The tooth extraction device of claim 11, wherein said spring biased prongs are actuated selectively by said top actuator and said slide actuator.

13. The tooth extraction device of claim 12, wherein said spring biased prongs in said fully retracted position captures the tooth and retains the tooth in a cavity of said handle body.

14. The tooth extraction device of claim 13, wherein said exterior is a smooth exterior.

15. The tooth extraction device of claim 14, wherein said smooth exterior having a pair of opposing arms extending therefrom for providing finger rests to said tooth extraction device.

16. A method for extracting a tooth, the method comprising the steps of:
providing a tooth extraction device having a handle body, wherein said handle body having an interior with a plunger slidably secured therein, an exterior, a top edge with a top actuator, and an open bottom end including a plurality of prongs, and further wherein said handle body having a slide actuator;
actuating said slide actuator downward relative to said handle body to actuate said prongs through said bottom end from a retracted position to an extended position;
positioning said prongs in said extended position over a tooth;
actuating said slide actuator upwards relative to said handle body to actuate said prongs through said bottom end from the extended position to the retracted position;
securing said prongs in said retracted position around the tooth, wherein said plunger connecting said slide actuator and said prongs; and
actuating said plunger and said prongs when said slide actuator is moved downward and upward relative to said handle body.

17. The method of extracting a tooth of claim 16, wherein said prongs are spring biased prongs.

18. The method of extracting a tooth of claim 17, wherein said spring biased prongs are actuated selectively by said top actuator and said slide actuator.

19. The method of extracting a tooth of claim 18, wherein said spring biased prongs in said fully retracted position captures the tooth and retains the tooth in a cavity of said handle body.

20. The method of extracting a tooth of claim 19, wherein said exterior having a pair of opposing arms extending therefrom for providing finger rests to said tooth extraction device.
